(19) United States
(12) Patent Application Publication
(10) Pub. No.: US 2020/0389435 A1
(43) Pub. Date: Dec. 10, 2020

(54) AUDITING SMART BITS

(71) Applicant: Syntegrity Networks Inc., Seattle, WA (US)

(72) Inventor: Nathanael Coffing, Seattle, WA (US)

(21) Appl. No.: 16/807,064

(22) Filed: Mar. 2, 2020

Related U.S. Application Data
(60) Provisional application No. 62/812,337, filed on Mar. 1, 2019.
(60) Provisional application No. 62/812,333, filed on Mar. 1, 2019.

(51) Int. Cl. H04L 29/06; H04L 9/06

(52) U.S. Cl. CPC H04L 63/0236; H04L 63/0281; H04L 2209/38; H04L 9/0637; H04L 9/0643; H04L 63/1425

(57) ABSTRACT

Systems and methods for decentralized risk propagation by auditing dynamically routed data are provided. A proxy installed on a client device receives a data stream and scans the data stream for classification parameters associated with sensitive data. The client information and the client device information are stored in a distributed ledger system. A data stream is broken down to data packets, tagged using known libraries containing characteristics of a classification, and routed based on applicable policies governing each classification. The tagged data packets and the metadata of the data packet are stored on the distributed ledger system. The path of the data packet, reasons for such routing, and whether consent was obtained to use the data in the data packet by service infrastructures are also stored in the distributed ledger system for auditability. Data stored in the distributed ledger may be stored as a hash digest.

### CROSS-REFERENCE TO RELATED APPLICATIONS

The present application claims the priority benefit of U.S. Provisional Patent Application No. 62/812,333 filed on Mar. 1, 2019 and entitled “Smart Bits” and of U.S. Provisional Patent Application No. 62/812,337 filed on Mar. 1, 2019 and entitled “Auditing Smart Bits,” the disclosures of which are incorporated herein by reference in their entirety.

### BACKGROUND OF THE INVENTION

### 1. Field of the Invention

The present invention generally relates to data routing. More specifically, the present invention relates to auditing the data routes.

### 2. Description of the Related Art

Presently available computing networks do not distinguish between different data types that are being transmitted among various applications and client devices in data communication networks. A data packet that is sent using such communication networks may be passed along by such devices, which has little or no visibility into the type of data being transmitted.

Classified or sensitive data (e.g., personal, financial, or health data) may be required to comply with various rules regarding security, inspection, and privacy regulations. Depending on type, the data may be subjected to different regulations. For example, Personally Identifiable Information (PII) data governed by California Consumer Privacy Act (CCPA) are required to flow through API gateway or a client device that is able to obtain consent from the owner of the data regarding use of the data. On the other hand, Payment Card Industry data (PCI) are required to travel through Intrusion Detection and Prevention Systems (IPS), which monitor traffic in the cardholder data environment and issue timely alerts upon suspicion of compromised data.

Currently, a data packet containing multiple different types of data may flows through a centralized system that does not distinguish between the different types of data. The data packet in its entirety must be transmitted through multiple security and inspection pathways that are required of the different data types within the packet. Such transmission increases traffic through each security and inspection infrastructure components, which in turn increases latency and the cost of operating a security infrastructure.

Because presently available communication networks do not distinguish between different data types, such communication networks further do not classify data, do not route (or re-route) data, and therefore do not have a need to audit the same. In systems that are capable of classifying different data types within packets, auditing the data routes of such packets may support compliance and reporting requirements in accordance with policies governing certain types of sensitive data.

There is, therefore, a need in the art for improved systems and methods of auditing data routes.

### SUMMARY OF THE CLAIMED INVENTION

Embodiments of the present invention provide for decentralized risk propagation by auditing dynamically routed data based on data type. A proxy installed on a client device receives a data stream and scans the data stream for classification parameters associated with sensitive data. The client information and the client device information may be stored in a distributed ledger system. A data stream may be broken down, for example, to data packets, classified using known libraries containing characteristics of a classification, and routed based on applicable policies governing each classification. The classification of each data packets are used to tag the data packets and the data packets and the metadata of the data packet are stored on the distributed ledger system. The path of the data packet, the reason for such routing, and whether consent was obtained to use the data in the data packet by service infrastructures are also stored in the distributed ledger system for auditability. Data stored in the distributed ledger may be stored as a hash digest.

Various embodiments may include methods for decentralized risk propagation by auditing dynamically routed data. Such methods may include installing a proxy on a client device in a communication network, scanning each received data packet for classification parameters associated with sensitive data, tagging the received data packets as sensitive based on the scan, routing the classified data packet in accordance with one or more services applicable to the sensitive data classification, seeking consent from the client, and storing the client and client device information, tagged data packets and the metadata of the tagged data packets, routing information, and consent information in the distributed ledger.

Further embodiments may include systems for auditing of routed data. Such system may include a client device capable of communicating over a communication network, a proxy installed on the client device, service infrastructures process the data packets according to applicable policies of the sensitive data, a honeypot device or network capable of handling highly sensitive or nefarious data, libraries containing characteristics of sensitive data to aid in data classification, a third party consent service, a hash generator, and a distributed ledger system. Systems may further include a memory and a processor that executes instructions stored in memory to install a proxy on a client device, monitor data streams received at the client device, classify the data packet, route the classified data packet to one or more services applicable to sensitive data classification, store information in the distributed ledger system, and update the distributed ledger system.

### BRIEF DESCRIPTION OF THE FIGURES

FIG. 1 illustrates an exemplary network environment in which a system for auditing may be implemented.

FIG. 2 is a flowchart illustrating an exemplary method for intelligent data auditing.

FIG. 3 is a flowchart illustrating an exemplary method for requesting consent.

FIG. 4 illustrates an exemplary computing system that may be used in implement an embodiment of the present invention.

### DETAILED DESCRIPTION

Embodiments of the present invention provide for decentralized risk propagation for systems that intelligently route data through communication networks (e.g., mesh networks, 5G networks). A proxy (e.g., installed on a client device in such a network) may scan incoming data packet to evaluate parameters indicative of certain data types (e.g., sensitive healthcare data). Such data may be classified, tagged based on the classification, and then routed (e.g., to a security service for heightened authentication) based on an applicable security policy.

Based on such classification (e.g., as health-related data), certain policies may be identified as being applicable. For example, such data may be classified as PII (personally identifiable information) and determined to be governed by California Consumer Privacy Act (CCPA). PCI (payment card industry) data, on the other hand, may be subject to Intrusion Detection and Prevention Systems (IPS). The classified data may then be routed (or re-routed) to services for additional authentication or other security protocols (e.g., deemed necessary or advisable in order to protect such data) in accordance with the applicable policies. The data packets may be constantly scanned for the classification to match against different types of classification and to update the current classification.

Such dynamic routing (and re-routing) may utilize software-defined networking to implement its policies. When data is classified as highly sensitive, for example, such data may be re-routed in real-time to specified services for application of additional classification, authentication, protection, risk mitigation, and other protocols (e.g., consent).

Alternatively, the data may be re-routed to designated honeypot devices or networks rather than continue on its original route. Honeypot devices and networks may exist in parallel with and may be configured to appear like one or more intended recipient computing devices and networks. The honeypot devices may be specifically designated, however, to handle data classified at or above a specified level of security risks (e.g., high risk). Such honeypot devices and networks may engage with the sensitive or high-risk data, but lack access to real and/or valid data maintained by the intended recipient. In addition, honeypot devices and networks may be isolated from the intended devices and networks. As such, engagement with the honeypot device or network may be monitored for security purposes, as well as research purposes, to identify activities likely to impact sensitive data. Because such sensitive data is not available via the honeypot devices or networks, however, such monitoring may reveal potential security risks without exposure of the sensitive data. The results of such monitoring may further inform a feedback loop to improve and update current classification, routing, and security processes.

If the data packet that was re-routed to a honeypot device is determined to lack security risks, the system may validate the client that has transmitted the data packet and process traffic from the client normally. In some embodiments, the data packet may be tagged in accordance with the monitoring results. The tagging of packets or data streams may be based on the threat landscape for who or what is providing the data. Such tag may be based on a hash of the data, as well as provided to a distributed ledger system. As such, data regarding the data stream and/or packet may be stored blockchain-style for subsequent use in audits. Thus, where there may be a threat level reclassification, for example, the system may dynamically reconfigure the traffic based on the content of the data stream as signified by the tag.

Using the tag and/or hash thereof, the distributed ledger system may maintain a log of the routing record of a data packet. For example, one service infrastructure may communicate with the next service infrastructure regarding the data packet. The distributed ledger system may record what data packet was transmitted, from which service infrastructure the data packet was transmitted, to which service infrastructure the data packet is headed, and why the data packet was transmitted. As such, the record may maintain metadata regarding the details of data packet routing. In particular, the routing data for a particular data packet may include information regarding a data source or type of entity that originated the data packet, attempts to access other data, and other behavioral characteristics. Maintaining such data and metadata in the routing log or record allows for inspection, verifications, and audits. Such audits may identify whether the data packet was indeed classified and routed properly among different service infrastructures. Other types of information may also be included in the record regarding the data packet, including ownership and affiliated entities, permissions/consent, etc.

The distributed ledger system may maintain a log of client data and the consent by the client to use the client data. For example, one of the security controls around the PII data may be based on the client acknowledging and consenting to use of their data by a specified service provider. A packet including such PII data may trigger, for example, the proxy to query a third party permission service regarding inter alia a user identifier (ID) of the client associated with the packet. If the third party permission service has a record corresponding to the user ID and the record includes indications of consent, the proxy may confirm the receipt of the consent data from the third party permission service and submit the consent data into the distributed ledger system to addition to the appropriate log.

In the event that the client has not yet provided consent to one or more uses of the client data, the proxy may prompt the client in the transaction to provide consent. Both the client consent and the data for which the consent was provided may be stored in the distributed ledger system. In an embodiment, the system may generate a hash digest of the client data and the consent data to be stored in the distributed ledger system.

The distributed ledger system may thereafter be accessible to the public, as well as verifiable by the public. In cases of sensitive data types, such distributed ledger system may provide for improved identification and tracking of risk in communications involving such sensitive data types.

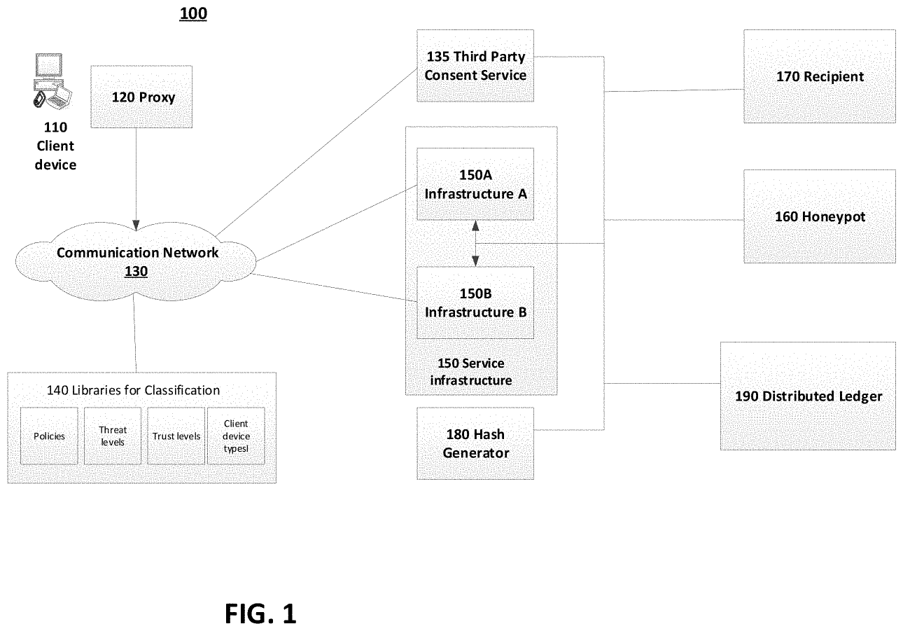

FIG. 1 illustrates an exemplary network environment 100 in which a system for data auditing may be implemented. As illustrated, an exemplary network environment 100 may include a client device 110, an associated proxy 120, a communication network 130, a third party consent service 135, a pluralities of libraries 140, a plurality of infrastructures 150A and 150B, honeypot 160, a recipient device 170, hash generator 180, and distributed ledger system 190.

The client device 110 may be any number of different electronic devices, such as general purpose computers, mobile phones, smartphones, smartwatches, wearable devices, personal digital assistants (PDAs), portable computing devices (e.g., laptop, netbook, tablets), desktop computing devices, handheld computing device, smart sensors, smart appliances, IoT devices, devices networked to controllers for smart control, servers and server systems (including cloud-based servers and server systems), or any other type of computing device capable of communicating over communication network 130. Such device 110 may also be configured to access data from other storage media, such as local caches, memory cards, or disk drives as may be appropriate in the case of downloaded services. Client device 110 may include standard hardware computing components such as network and media interfaces, non-transitory computer-readable storage (memory), and processors for executing instructions that may be stored in memory.

For simplicity, only one client device 110 is illustrated; however, the recipient 170 may receive routed data from a plurality of client devices 110. Proxy 120 may be any intelligent HTTP proxy that provides dynamic service discovery, load balancing, circuit breakers, traffic routing, metrics and more. In an embodiment, the proxy 120 is installed on or otherwise associated with each client devices 110. Such proxy 112 may scan the data packet upon receipt at the associated client device 110 in real-time and evaluate in accordance with any policies applicable to the associated client device 110 prior to releasing to a next client device 110 in a current route.

Proxy 120 may use libraries 140 accessible via the communication network 130 for classifying different types of data. In addition, new libraries 140 may be developed, or existing libraries 140 may be continually updated in view of new information regarding sensitive data types and characteristics thereof, as well as libraries 140 pertaining to different types of policies, threat levels, applications and respective trust levels, and client device types. Proxy 120 may tag the packets of data streams based on the threat landscape for who or what is providing the data and send the data to the hash generator 180 or to the distributed ledger system 190.

Communication network 130 may include a local, proprietary network (e.g., an intranet) and/or may be a part of a larger wide-area network. The communications network 130 may be a local area network (LAN), which may be communicatively coupled to a wide area network (WAN) such as the Internet. The Internet is a broad network of interconnected computers and servers allowing for the transmission and exchange of Internet Protocol (IP) data between users connected through a network service provider. Examples of network service providers are the public switched telephone network, cellular or mobile service providers, a cable service provider, a provider of digital subscriber line (DSL) services, or a satellite service provider. Communications network 130 allows for communication between the various components of network environment 100.

The communication network 130 transmits scanned data packets from the proxy 120 to a plurality of infrastructures 150A and 150B that provide different services for authentication or security protocols in accordance with the applicable policies. For example, an API gateway may serve as an infrastructure for PII data. Another infrastructure may be IPS for PCI data. Web Application Firewall (WAF) is another example of an infrastructure for PCI and PII data. For simplicity, only two infrastructures are illustrated as in FIG. 1.

In an embodiment, a data packet of the data stream that was identified as PII may flow into API gateway infrastructure, whereas another data packet of the same data stream identified as PCI may flow through IPS infrastructure. The data packet may be rerouted from one infrastructure to another, until the data packet reaches the recipient 170, or a honeypot 160. The honeypot 160 may designated to monitor and handle data classified as representing a certain level or type of security risk. The monitored data at the honeypot 160 may be used to further update the libraries 140 to improve current classification.

A third party consent service 135 is queried by the proxy 120 to request consent from the client on the client device 110 or the recipient 170 as required by the policies governing the sensitive data packet. The data received by the third party consent service 135 and the consent received by the third party consent service 135 are sent directly to the distributed ledger 190 or to the hash generator 180 and then to the distributed ledger 190.

Hash generator 180 generates a hash digest of data the generator receives from third party consent service 135, service infrastructure 150A and 150B, and the communication between the services. In an embodiment, the hash generator 180 may generate a hash digest of the data packet in the service infrastructure 150A or 150B, a hash digest of the metadata of such data packet in the infrastructure, and a hash digest of the consent given by the client. The hash generator 180 may utilize any hash function known in the art (e.g., MD-5 or SHA-1) to generate hash digests. The hash digest generated by the hash generator 180 are provided to the distributed ledger system 190.

The distributed ledger system 190 stores data received from the proxy 120, the hash generator 180, third party consent service 135, service infrastructure 150A and 150B regarding the data stream and data packets. In some embodiments, the distributed ledger system 190 maintains such data in blockchain-style records or logs for subsequent use in audits.

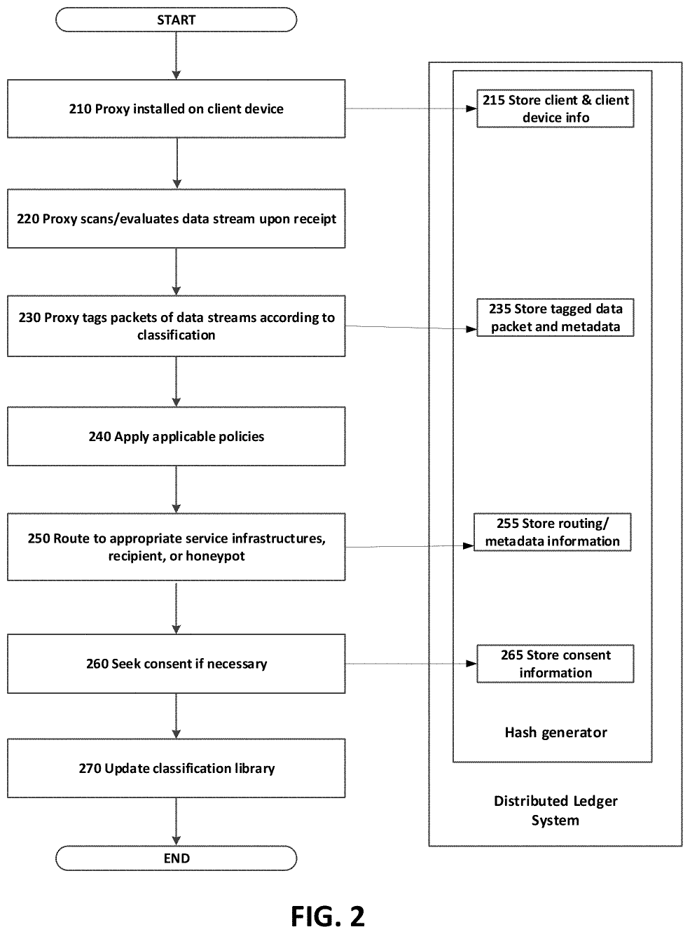

FIG. 2 illustrates a flowchart illustrating an exemplary method for data auditing. At step 210, the proxy (or agent) 120 is installed on the client device 110. The information regarding the client device 120, including the identity of the client, may be stored in the distributed ledger 190 at step 215. The information regarding the client and the client device may also be stored in the distributed ledger 190 as a hash after passing through the hash generator 180.

At step 220, the proxy 120 scans the data stream upon receipt to evaluate the data for any policies applicable to the associated client device 110. The data may be scanned for defined factors to identify the policies that are applicable to each data packet of the data stream. Certain financial data may include or exhibit parameters that may be used to classify its bits or packets as potentially including sensitive financial data; likewise, health-related data may include or exhibit certain characteristics that may be used to classify packets that contain the same. Existing libraries that contain categories and levels of sensitive data may be used in classification.

At step 230, the proxy 120 tags packets of data from the data stream according to the characteristics of sensitive data. One data stream may contain many packets of data that are subjected to different policies regarding sensitive data and each packets are tagged with appropriate classification according to the characteristics the packets exhibit.

At step 235, the tagged data packet are stored in the distributed ledger system 190. The tagged data may be stored as a hash digest in the distributed ledger system 190 after being transmitted to the hash generator 180 before reaching the distributed ledger system 190. The metadata regarding the tagged data packet may also be stored in the distributed ledger system 190. The metadata includes information regarding the data source, type of entity that originated the data packet, attempts by the data packet to access other data, and other behavioral characteristics.

At step 240, appropriate policies governing the data packets are applied according to the classification of the data packet. Such policy application and enforcement may be based on each data packets being routed to appropriate service infrastructures to handle the data packets at step 250. Depending on the classification, sensitivity, or threat level of the data packet, the data packets may be re-routed to a honeypot device or network 150. The data may continue the current route to the recipient 170. The data regarding the routing path the data packet took and the reason for the data packet to take such a path may be stored in the distributed ledger system 190. The data regarding the routing path may also be first transmitted to the hash generator 180 before being stored in the distributed ledger system 190.

If the service infrastructure 150A or 150B required the client or any other owner of the data to give consent, the proxy 120 queries the third party consent service 135 whether the consent was granted in using the data at step 260. If consent was granted, the proxy 120 stores the data for which the consent was necessary and the consent granted in the distributed ledger system 190 at step 265. This data may also be first transmitted to the hash generator 180 before being stored in the distributed ledger system 190.

At step 270, the system updates the libraries for classification of the data 140 based on the monitored data. If any of the data packet has changed its classification, the library relevant to the data packet will be updated to improve classification and routing in future.

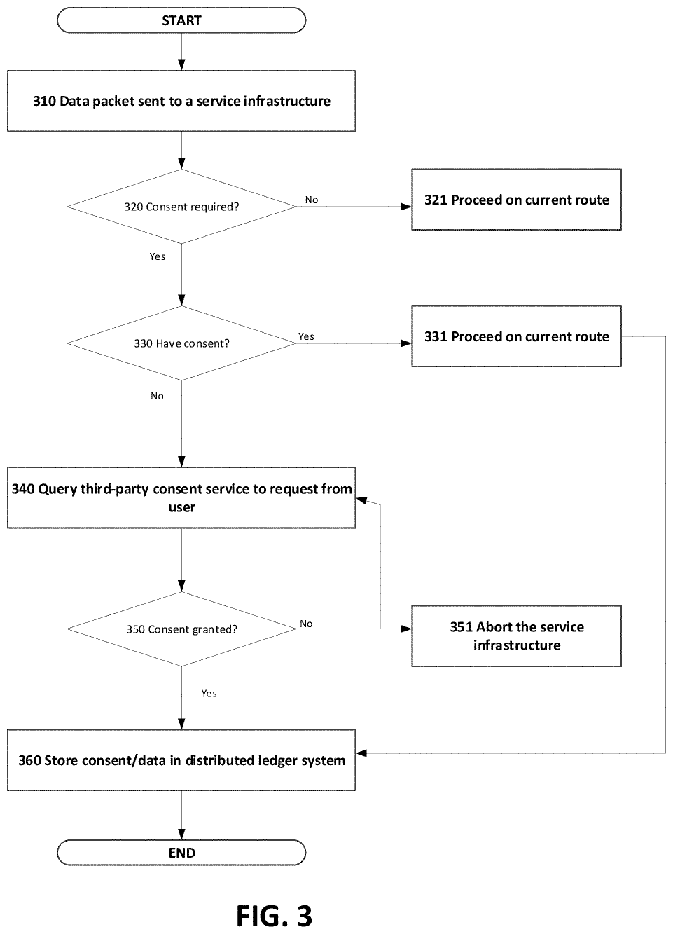

FIG. 3 illustrates an exemplary method for requesting consent. A data packet from a data stream is sent to the appropriate service infrastructure 150 that handles the type of classification of data that the data packet is at step 310. At step 320, the service infrastructure 150 determines whether consent is required to use the data packet the service infrastructure 150 received. If consent is not required, the data packet proceeds on the current route without consent at step 321. If consent is required, the proxy 120 determines whether consent is already obtained at step 330. If consent was already obtained, the data packet proceeds on the current route with the consent at step 331. If consent is required but not yet obtained, the proxy 120 queries a third party consent service 135 to request consent from the client or any other owner of the data at step 340.

At step 350, the system determines whether the consent was granted after the request to obtain consent. If consent is not granted, the system may keep requesting the client to provide consent by returning to step 340 or abort the service infrastructure 150 at step 351. If consent is granted, the consent and the data for which required the consent may be stored in the distributed ledger system 190 at step 360. Such data may be stored as a hash after being passed through the hash generator 180.

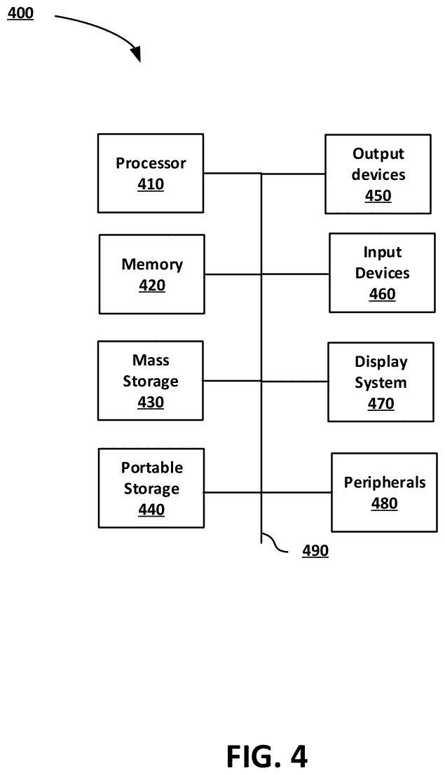

FIG. 4 illustrates an exemplary computing system 400 that may be used to implement an embodiment of the present invention. System 400 of FIG. 4 may be implemented in the contexts of the client device 110. The computing system 400 of FIG. 4 includes one or more processors 410 and memory 420. Main memory 420 stores, in part, instructions and data for execution by processor 410. Main memory 420 can store the executable code when in operation. The system 400 of FIG. 4 further includes a mass storage device 430, portable storage medium drive(s) 440, output devices 450, user input devices 460, a graphics display 470, and peripheral devices 480.

The components shown in FIG. 4 are depicted as being connected via a single bus 390. However, the components may be connected through one or more data transport means. For example, processor unit 410 and main memory 410 may be connected via a local microprocessor bus 490, and the mass storage device 430, peripheral device(s) 480, portable storage device 440, and display system 470 may be connected via one or more input/output (I/O) buses 490.

Mass storage device 430, which may be implemented with a magnetic disk drive or an optical disk drive, is a non-volatile storage device for storing data and instructions for use by processor unit 410. Mass storage device 430 can store the system software for implementing embodiments of the present invention for purposes of loading that software into main memory 310.

Portable storage device 440 operates in conjunction with a portable non-volatile storage medium, such as a floppy disk, compact disk (CD) or digital video disc (DVD), to input and output data and code to and from the computer system 400 of FIG. 4. The system software for implementing embodiments of the present invention may be stored on such a portable medium and input to the computer system 400 via the portable storage device 440.

Input devices 460 provide a portion of a user interface. Input devices 460 may include an alpha-numeric keypad, such as a keyboard, for inputting alpha-numeric and other information, or a pointing device, such as a mouse, a trackball, stylus, or cursor direction keys. Additionally, the system 400 as shown in FIG. 4 includes output devices 450. Examples of suitable output devices include speakers, printers, network interfaces, and monitors.

Display system 470 may include a liquid crystal display (LCD) or other suitable display device. Display system 470 receives textual and graphical information, and processes the information for output to the display device.

Peripherals 480 may include any type of computer support device to add additional functionality to the computer system. For example, peripheral device(s) 480 may include a modem or a router.

The components contained in the computer system 400 of FIG. 4 are those typically found in computer systems that may be suitable for use with embodiments of the present invention and are intended to represent a broad category of such computer components that are well known in the art. Thus, the computer system 400 of FIG. 4 can be a personal computer, hand held computing device, telephone, mobile computing device, workstation, server, minicomputer, mainframe computer, or any other computing device. The computer can also include different bus configurations, networked platforms, multi-processor platforms, etc. Various operating systems can be used including Unix, Linux, Windows, Macintosh OS, Palm OS, and other suitable operating systems.

The components contained in the computing systems performing the methods and functions disclosed herein are those typically found in computer systems that may be suitable for use with embodiments of the present invention and are intended to represent a broad category of such computer components that are well known in the art. Such computing components may include any variety of computing components known in the art, including memory, processors, and network communication interfaces. Further, the present invention may be implemented in an application that may be operable using a variety of devices. Non-transitory computer-readable storage media refer to any medium or media that participate in providing instructions to a central processing unit (CPU) for execution. Such media can take many forms, including, but not limited to, non-volatile and volatile media such as optical or magnetic disks and dynamic memory, respectively. Common forms of non-transitory computer-readable media include, for example, a floppy disk, a flexible disk, a hard disk, magnetic tape, any other magnetic medium, a CD-ROM disk, digital video disk (DVD), any other optical medium, RAM, PROM, EPROM, a FLASHEPROM, and any other memory chip or cartridge.

Various forms of transmission media may be involved in carrying one or more sequences of one or more instructions to a CPU for execution. A bus carries the data to system RAM, from which a CPU retrieves and executes the instructions. The instructions received by system RAM can optionally be stored on a fixed disk either before or after execution by a CPU. Various forms of storage may likewise be implemented as well as the necessary network interfaces and network topologies to implement the same.

The foregoing detailed description of the technology has been presented for purposes of illustration and description. It is not intended to be exhaustive or to limit the technology to the precise form disclosed. Many modifications and variations are possible in light of the above teaching. The described embodiments were chosen in order to best explain the principles of the technology, its practical application, and to enable others skilled in the art to utilize the technology in various embodiments and with various modifications as are suited to the particular use contemplated. It is intended that the scope of the technology be defined by the claim.

What is claimed is:

1. A method for decentralized risk propagation, the method comprising:
receiving information regarding a classification of at least one data packet as sensitive based on a scan detecting one or more parameters associated with a sensitive data type;
tagging the at least one data packet with a tag in accordance with the classification, wherein the tag is indicative of a route of the at least one data packet;
updating a distributed ledger system associated with the at least one data packet, wherein the distributed ledger system associated with the at least one data packet is updated to include the tag; and
auditing the at least one data packet based on the updated distributed ledger system.

2. The method of claim 1, wherein the scan detecting the one or more parameters associated with the sensitive data type is performed by a proxy installed on a client device associated with the at least one data packet.

3. The method of claim 1, wherein tagging the data packet is further based on a library that stores a plurality of parameters corresponding to the sensitive data type.

4. The method of claim 1, wherein updating the distributed ledger system is further based on a hash digest of the at least one data packet.

5. The method of claim 1, wherein updating the distributed ledger system is further based on metadata regarding the at least one data packet.

6. The method of claim 5, wherein the metadata includes at least one of a source of the at least one data packet, attempts to access other data, and behavioral characteristics of the at least one data packet.

7. The method of claim 1, wherein updating the distributed ledger system is further based on data regarding a client device associated with the at least one data packet.

8. The method of claim 1, wherein updating the distributed ledger is further based on information about the route of the at least one data packet.

9. The method of claim 1, wherein updating the distributed ledger is further based on consent information from an owner of the at least one data packet.

10. The method of claim 1, wherein the distributed ledger includes a plurality of blockchain records.

11. A system for decentralized risk propagation, the system comprising:
a distributed ledger system that stores information regarding a plurality of data packets; and
a proxy installed on a client device and executable by a processor, wherein the execution of the proxy:
receives information regarding classification of at least one data packet as sensitive based on a scan detecting one or more parameters associated with a sensitive data type;
tags the at least one data packet with a tag in accordance with the classification, wherein the tag is indicative of a route of the at least one data packet;
updates the distributed ledger system associated with the at least one data packet, wherein the distributed ledger system associated with the at least one data packet is updated to include the tag; and
audits the at least one data packet based on the updated distributed ledger system.

12. The system of claim 11, wherein the proxy further performs the scan that detects the one or more parameters associated with the sensitive data type.

13. The system of claim 11, further comprising a library that stores a plurality of parameters of the sensitive data type, wherein the proxy tags the at least one data packet based on the library.

14. The system of claim 11, further comprising a hash generator that generates a hash digest of the at least one data packet, wherein the distributed ledger system is updated based on the hash digest of the at least one data packet.

15. The system of claim 11, wherein the distributed ledger system is updated based on metadata regarding the at least one data packet.

16. The system of claim 15, wherein the metadata includes at least one of source of the at least one data packet, attempts to access other data, and behavioral characteristics of the at least one data packet.

17. The system of claim 11, wherein the distributed ledger system is updated based on data regarding a client device associated with the at least one data packet.

18. The system of claim 11, further comprising one or more service infrastructures associated with the route of the at least one data packet, wherein the distributed ledger system is updated based on information regarding the service infrastructures associated with the route of the at least one data packet.

19. The system of claim 11, further comprising a consent service that confirms consent information associated with the at least one data packet by an owner of the at least one data packet, wherein the distributed ledger system is updated based on the consent information.

20. The system of claim 11, wherein the distributed ledger system includes a plurality of blockchain records.

21. A non-transitory computer-readable storage medium, having embodied thereon a program executable by a processor to perform a method for managing data stream identity, the method comprising:
receiving information regarding classification of at least one data packet as sensitive based on a scan detecting one or more parameters associated with a sensitive data type;
tagging the at least one data packet with a tag in accordance with the classification, wherein the tag is indicative of a route of the at least one data packet;
updating a distributed ledger system associated with the at least one data packet, wherein the distributed ledger system associated with the at least one data packet is updated to include the tag; and
auditing the at least one data packet based on the updated distributed ledger system.
